(19) United States
(12) Patent Application Publication
(10) Pub. No.: US 2025/0286451 A1
(43) Pub. Date: Sep. 11, 2025

(54) DUAL OUTPUT VOLTAGE CONVERSION CIRCUIT IN A POWER MANAGEMENT CIRCUIT

(71) Applicant: Qorvo US, Inc., Greensboro, NC (US)

(72) Inventor: Nadim Khlat, Cugnaux (FR)

(21) Appl. No.: 19/038,799

(22) Filed: Jan. 28, 2025

Related U.S. Application Data
(60) Provisional application No. 63/563,659, filed on Mar. 11, 2024.

(51) Int. Cl. H02M 3/07; H01M 10/42; H02M 1/00

(52) U.S. Cl. CPC H02M 3/07; H02M 1/0067; H01M 10/425; H01M 2010/4271

(57) ABSTRACT

A dual output voltage conversion circuit, which can be provided in a power management circuit in a wireless device, is disclosed. Herein, the dual output voltage conversion circuit includes a main multi-level charge pump (MCP) and a lightweight MCP that is simplified from the main MCP to help reduce a footprint of the power management circuit. Specifically, the main MCP is configured to generate a first low-frequency voltage as a function of a battery voltage and the lightweight MCP is configured to concurrently generate a second low-frequency voltage as a function of a transfer voltage provided by the main MCP and so generated to be higher than the battery voltage. In an embodiment, the dual output voltage conversion circuit can be provided in the power management circuit to enable multiple simultaneous transmissions in the wireless device.

### RELATED APPLICATIONS

This application claims the benefit of U.S. provisional patent application Ser. No. 63/563,659, filed on Mar. 11, 2024, the disclosure of which is hereby incorporated herein by reference in its entirety.

### FIELD OF THE DISCLOSURE

The technology of the disclosure relates generally to a voltage converter in a power management circuit of a wireless device.

### BACKGROUND

Mobile communication devices have become increasingly common in current society for providing wireless communication services. The prevalence of these mobile communication devices is driven in part by the many functions that are now enabled on such devices. Increased processing capabilities in such devices means that mobile communication devices have evolved from being pure communication tools into sophisticated mobile multimedia centers that enable enhanced user experiences.

A state-of-the-art mobile communication device must be able to communicate a radio frequency (RF) signal(s) in a variety of wireless communication systems, such as long-term evolution (LTE) and new radio (NR), based on a variety of transmit/receive configurations, such as uplink/downlink multiple-input, multiple-output (UL/DL-MIMO), enhanced dual-connectivity (EN-DC), and diversity receive (DRX). As an example, many multi-transmission proposals have been made for third-generation partnership project (3GPP) release 18 to support concurrent UL-MIMO and EN-DC transmissions on multiple RF bands. In this regard, a wireless communication device is required to concurrently transmit at least three RF signals (2×MIMO+1×EN-DC). In this regard, the mobile communication device must employ a power management circuit that can simultaneously support multiple power amplifiers to enable multiple concurrent transmissions.

### SUMMARY

Embodiments of the disclosure relate to a dual output voltage conversion circuit, which can be provided in a power management circuit in a wireless device. Herein, the dual output voltage conversion circuit includes a main multi-level charge pump (MCP) and a lightweight MCP that is simplified from the main MCP to help reduce a footprint of the power management circuit. Specifically, the main MCP is configured to generate a first low-frequency voltage as a function of a battery voltage and the lightweight MCP is configured to concurrently generate a second low-frequency voltage as a function of a transfer voltage provided by the main MCP and so generated to be higher than the battery voltage. In an embodiment, the dual output voltage conversion circuit can be provided in the power management circuit to enable multiple simultaneous transmissions in the wireless device.

In one aspect, a dual output voltage conversion circuit is provided. The dual output voltage conversion circuit includes a main MCP. The main MCP is configured to generate a first low-frequency voltage at a first voltage output as a function of a battery voltage based on a first duty cycle. The main MCP is also configured to output the first low-frequency voltage as a transfer voltage when the first low-frequency voltage is higher than the battery voltage. The dual output voltage conversion circuit also includes a lightweight MCP. The lightweight MCP is configured to receive the transfer voltage from the main MCP. The lightweight MCP is also configured to generate a second low-frequency voltage at a second voltage output as a function of the transfer voltage based on a second duty cycle.

In another aspect, a wireless device is provided. The wireless device includes a power management circuit. The power management circuit includes a dual output voltage conversion circuit. The dual output voltage conversion circuit includes a main MCP. The main MCP is configured to generate a first low-frequency voltage at a first voltage output as a function of a battery voltage based on a first duty cycle. The main MCP is also configured to output the first low-frequency voltage as a transfer voltage when the first low-frequency voltage is higher than the battery voltage. The dual output voltage conversion circuit also includes a lightweight MCP. The lightweight MCP is configured to receive the transfer voltage from the main MCP. The lightweight MCP is also configured to generate a second low-frequency voltage at a second voltage output as a function of the transfer voltage based on a second duty cycle.

In another aspect, a method for operating a dual output voltage conversion circuit is provided. The method includes generating a first low-frequency voltage at a first voltage output as a function of a battery voltage based on a first duty cycle. The method also includes outputting the first low-frequency voltage as a transfer voltage when the first low-frequency voltage is higher than the battery voltage. The method also includes generating a second low-frequency voltage at a second voltage output as a function of the transfer voltage based on a second duty cycle.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of an exemplary dual output voltage conversion circuit configured according to an embodiment of the present disclosure;

FIG. 2 is a diagram illustrating one of many operating scenarios of the dual output voltage conversion circuit of FIG. 1;

FIG. 3 is a schematic diagram of an exemplary dual output voltage conversion circuit configured according to another embodiment of the present disclosure;

FIG. 4 is a schematic diagram of an exemplary dual output voltage conversion circuit configured according to an alternative embodiment of the present disclosure;

FIG. 5 is a schematic diagram of an exemplary power management circuit wherein the dual output voltage conversion circuits of FIGS. 1, 3, and 4 can be provided;

FIG. 6 is a schematic diagram of an exemplary communication device wherein the power management circuit of FIG. 5 can be provided; and

FIG. 7 is a flowchart of an exemplary process for operating the dual output voltage conversion circuits of FIGS. 1, 3, and 4.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments of the disclosure relate to a dual output voltage conversion circuit, which can be provided in a power management circuit in a wireless device. Herein, the dual output voltage conversion circuit includes a main multi-level charge pump (MCP) and a lightweight MCP that is simplified from the main MCP to help reduce the footprint of the power management circuit. Specifically, the main MCP is configured to generate a first low-frequency voltage as a function of a battery voltage and the lightweight MCP is configured to concurrently generate a second low-frequency voltage as a function of a transfer voltage provided by the main MCP and so generated to be higher than the battery voltage. In an embodiment, the dual output voltage conversion circuit can be provided in the power management circuit to enable multiple simultaneous transmissions in the wireless device.

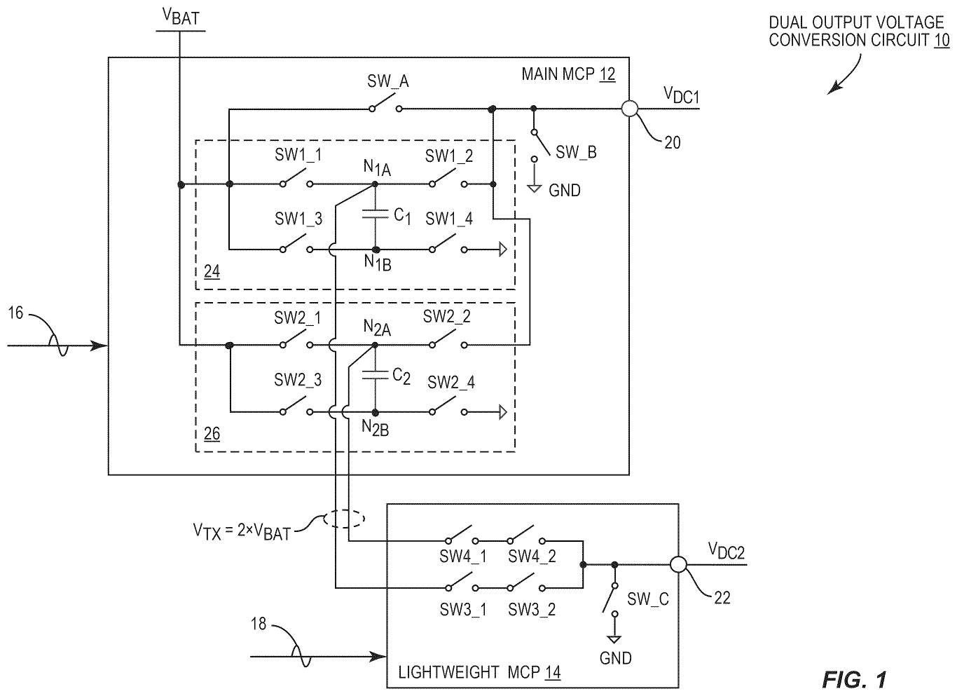

FIG. 1 is a schematic diagram of an exemplary dual output voltage conversion circuit 10 wherein a main MCP 12 and a lightweight MCP 14 are configured according to an embodiment of the present disclosure to simultaneously generate a first low-frequency voltage V_{DC1} and a second low-frequency voltage V_{DC2}. In a non-limiting example, each of the first low-frequency voltage V_{DC1} and the second low-frequency voltage V_{DC2} can be a direct-current (DC) voltage.

In an embodiment, the main MCP 12 is a buck-boost DC-DC voltage conversion circuit that can toggle between a buck mode and a boost mode in accordance with a first duty cycle 16 to generate the first low-frequency voltage V_{DC1} as a function (e.g., a multiple) of a battery voltage V_{BAT}. The lightweight MCP 14, on the other hand, can be a buck-only DC-DC voltage conversion circuit that receives a transfer voltage V_{TX}, which is higher than the battery voltage V_{BAT}, from the main MCP 12. Accordingly, the lightweight MCP 14 can operate based on a second duty cycle 18 to generate the second low-frequency voltage V_{DC2} as a function (e.g., a fraction) of the transfer voltage V_{TX}. In a non-limiting example, the first duty cycle 16 and the second duty cycle 18 can both be pulse-width modulation (PWM) signals. By operating based on the transfer voltage V_{TX} that is higher than the battery voltage V_{BAT}, it is possible to eliminate some components (e.g., capacitors) required for boosting the battery voltage V_{BAT} from the lightweight MCP 14. As a result, it is possible to reduce the footprint of the lightweight MCP 14 and the dual output voltage conversion circuit 10 as a whole.

In a non-limiting example, the main MCP 12 can be configured to toggle between a zero-times multiple of the battery voltage V_{BAT} (0×V_{BAT}), a one-times multiple of the battery voltage V_{BAT} (1×V_{BAT}), and a two-times multiple of the battery voltage V_{BAT} (2×V_{BAT}) in accordance with the first duty cycle 16 to thereby generate the first low-frequency voltage V_{DC1} at a first voltage output 20. Herein, the first duty cycle 16 defines a respective proportion of the 0×V_{BAT}, 1×V_{BAT}, and 2×V_{BAT} that make up the first low-frequency voltage V_{DC1}. In one example, the first duty cycle 16 can be so determined to cause the main MCP 12 to toggle between 1×V_{BAT} and 2×V_{BAT} based on a 75%-25% ratio to thereby generate the first low-frequency voltage V_{DC1} that includes 75% of 1×V_{BAT} and 25% of 2×V_{BAT}. In another example, the first duty cycle 16 can be so determined to cause the main MCP 12 to toggle between 1×V_{BAT} and 2×V_{BAT} based on a 25%-75% ratio to thereby generate the first low-frequency voltage V_{DC1} that includes 25% of 1×V_{BAT} and 75% of 2×V_{BAT}. In yet another example, the first duty cycle 16 can be so determined to cause the main MCP 12 to toggle between 0×V_{BAT}, 1×V_{BAT} and 2×V_{BAT} based on a 25%-25%-50% ratio to thereby generate the first low-frequency voltage V_{DC1} that includes 25% of 0×V_{BAT}, 25% of 1×V_{BAT}, and 50% of 2×V_{BAT}.

In the context of the present disclosure, the proportion of the 2×V_{BAT} in the first low-frequency voltage V_{DC1} is used to define the duty cycle rate of the first duty cycle 16. In this regard, the first duty cycle 16 that defines 75% of 2×V_{BAT} in the first low-frequency voltage V_{DC1} is said to be higher than the first duty cycle 16 that defines 25% of 2×V_{BAT} in the first low-frequency voltage V_{DC1}.

In this embodiment, the main MCP 12 is configured to provide the transfer voltage V_{TX} that equals 2×V_{BAT} (V_{TX}=2×V_{BAT}) to the lightweight MCP 14. The lightweight MCP 14 can be configured to toggle between a one-times multiple of the transfer voltage V_{TX} (1×V_{TX}=2×V_{BAT}), a one-half-times multiple of the transfer voltage V_{TX} (0.5×V_{TX}=1×V_{BAT}), and a zero-times multiple of the transfer voltage V_{TX} (0×V_{TX}=0×V_{BAT}) in accordance with the second duty cycle 18 to thereby generate the second low-frequency voltage V_{DC2}. As an example, to generate the second low-frequency voltage V_{DC1} at the battery voltage V_{BAT}, the second duty cycle 18 can be so determined to cause the lightweight MCP 14 to toggle between 0×V_{TX} (a.k.a. 0×V_{BAT}) and 1×V_{TX} (a.k.a. 2×V_{BAT}) based on a 50%-50% ratio. According to the same duty cycle rate definition provided above, the second duty cycle 18 is said to have a 50% duty cycle rate. Thus, the 50% duty cycle rate of the second duty cycle 18 can be said to be lower than the 75% duty cycle rate of the first duty cycle 16, but higher than the 25% duty cycle rate of the first duty cycle 16, as described in the earlier examples.

In an embodiment, the main MCP 12 includes a first buck-boost voltage converter 24 and a second buck-boost voltage converter 26. The first buck-boost voltage converter 24 and the second buck-boost voltage converter 26 are coupled in parallel between the battery voltage V_{BAT} and the first voltage output 20. Herein, the first buck-boost voltage converter 24 and the second buck-boost voltage converter 26 are configured to alternately provide the transfer voltage V_{TX} to the lightweight MCP 14. As described below, by configuring the first buck-boost voltage converter 24 and the second buck-boost voltage converter 26 to alternately provide the transfer voltage V_{TX} to the lightweight MCP 14, it is possible to ensure that the lightweight MCP 14 can consistently receive the transfer voltage V_{TX} that equals two times the battery voltage V_{BAT}.

The main MCP 12 may be configured to include a first common switch SW_A and a second common switch SW_B. The first common switch SW_A may be coupled between the battery voltage V_{BAT} and the first voltage output 20, and the second common switch SW_B may be coupled between the first voltage output 20 and a ground (GND).

The first buck-boost voltage converter 24 includes a respective first switch SW1_1 coupled between the battery voltage V_{BAT} and a respective first middle node NIA, a respective second switch SW1_2 coupled between the respective first middle node N_{1A} and the first voltage output 20, a respective third switch SW1_3 coupled between the battery voltage V_{BAT} and a respective second middle node N_{1B}, a respective fourth switch SW1_4 coupled between the respective second middle node N_{1B} and the GND, and a respective fly capacitor C₁ coupled between the respective first middle node N_{1A} and the respective second middle node N_{1B}.

The second buck-boost voltage converter 26 includes a respective first switch SW2_1 coupled between the battery voltage V_{BAT} and a respective first middle node N_{2A}, a respective second switch SW2_2 coupled between the respective first middle node N_{2A} and the first voltage output 20, a respective third switch SW2_3 coupled between the battery voltage V_{BAT} and a respective second middle node N_{2B}, a respective fourth switch SW2_4 coupled between the respective second middle node N_{2B} and the GND, and a respective fly capacitor C₂ coupled between the respective first middle node N_{2A} and the respective second middle node N_{2B}.

According to an embodiment of the present disclosure, the respective first middle node NIA in the first buck-boost voltage converter 24 and the respective first middle node N_{2A} in the second buck-boost voltage converter 26 are each coupled to the lightweight MCP 14. Accordingly, the first buck-boost voltage converter 24 and the second buck-boost voltage converter 26 are configured to alternately provide the transfer voltage V_{TX} to the lightweight MCP 14 by alternately coupling the respective first middle node N_{1A} and the respective first middle node N_{2A} to the lightweight MCP 14.

Herein, all switches in the main MCP 12 and the lightweight MCP 14 are assumed to be open unless explicitly stated as being closed. In a non-limiting example, the main MCP 12 can output 1×V_{BAT} at the first voltage output 20 by closing the first common switch SW_A and output 0×V_{BAT} at the first voltage output 20 by closing the second common switch SW_B. To output 2×V_{BAT} at the first voltage output 20, the main MCP 12 must first charge the first fly capacitor C₁ and/or the second fly capacitor C₂ to the battery voltage V_{BAT}.

In an example, to configure the first buck-boost voltage converter 24 to output 2×V_{BAT} at the first voltage output 20, the respective first switch SW1_1 and the respective fourth switch SW1_4 are first closed, while the respective second switch SW1_2 and the respective third switch SW1_3 are opened, to thereby charge the first fly capacitor C₁ to the battery voltage at the respective first middle node N_{1A}. Subsequently, the respective second switch SW1_2 and the respective third switch SW1_3 are closed, while the respective first switch SW1_1 and the respective fourth switch SW1_4 are opened. As a result, the voltage at the respective first middle node NIA will be equal to 2×V_{BAT}. Accordingly, the first buck-boost voltage converter 24 can output 2×V_{BAT} at the first voltage output 20 and provide the transfer voltage V_{TX} that is substantially equal to 2×V_{BAT} to the lightweight MCP 14 via the respective first middle node NIA. Herein, the transfer voltage V_{TX} is said to be substantially equal to (a.k.a. approximately equal to) 2×V_{BAT} when a difference between the transfer voltage V_{TX} is equal to ±1% of 2×V_{BAT} (V_{TX}≈2×V_{BAT}±1%).

In another example, to configure the second buck-boost voltage converter 26 to output 2×V_{BAT} at the first voltage output 20, the respective first switch SW2_1 and the respective fourth switch SW2_4 are first closed, while the respective second switch SW2_2 and the respective third switch SW2_3 are opened, to thereby charge the second fly capacitor C₂ to the battery voltage at the respective first middle node N_{2A}. Subsequently, the respective second switch SW2_2 and the respective third switch SW2_3 are closed, while the respective first switch SW2_1 and the respective fourth switch SW2_4 are opened. As a result, the voltage at the respective first middle node N_{2A} will be equal to 2×V_{BAT}. Accordingly, the second buck-boost voltage converter 26 can output 2×V_{BAT} at the first voltage output 20 and provide the transfer voltage V_{TX} that is substantially equal to 2×V_{BAT} to the lightweight MCP 14 via the respective first middle node N_{2A}.

In an embodiment, to ensure that the lightweight MCP 14 can consistently receive the transfer voltage V_{TX} that is substantially equal to 2×_{BAT}, the main MCP 12 can be configured to alternately charge the first fly capacitor C₁ in the first buck-boost voltage converter 24 and the second fly capacitor C₂ in the second buck-boost voltage converter 26. Specifically, the respective second switch SW1_2 and the respective third switch SW1_3 in the first buck-boost voltage converter 24 will be closed in order to provide the transfer voltage V_{TX} that is substantially equal to 2×V_{BAT} to the lightweight MCP 14 via the respective first middle node N_{1A}. In the meantime, the respective first switch SW2_1 and the respective fourth switch SW2_4 in the second buck-boost voltage converter 26 are closed in order to charge the respective second fly capacitor C₂ to the battery voltage V_{BAT}. When the respective second fly capacitor C₂ is charged up to the battery voltage V_{BAT}, the respective second switch SW2_2 and the respective third switch SW2_3 in the second buck-boost voltage converter 26 will be closed in order to provide the transfer voltage V_{TX} that is substantially equal to 2×V_{BAT} to the lightweight MCP 14 via the respective first middle node N_{2A}. In the meantime, the respective first switch SW1_1 and the respective fourth switch SW1_4 in the first buck-boost voltage converter 24 are closed in order to charge the respective first fly capacitor C₁ to the battery voltage V_{BAT}.

The lightweight MCP 14 includes a third common switch SW_C that is coupled between the second voltage output 22 and the GND. The lightweight MCP 14 also includes a first pair of switches SW3_1, SW3_2 that are coupled in series between the respective first middle node NIA in the first buck-boost voltage converter 24 and the second voltage output 22. The lightweight MCP 14 also includes a second pair of switches SW4_1, SW4_2 that are coupled in series between the respective first middle node N_{2A} in the second buck-boost voltage converter 26 and the second voltage output 22.

The third common switch SW_C can be closed in order to output 0×V_{BAT} at the second voltage output 22. To output 2×V_{BAT} at the second voltage output 22, the first pair of switches SW3_1, SW3_2 can be closed when the first buck-boost voltage converter 24 provides the transfer voltage V_{TX} via the respective first middle node NIA. Alternatively, the second pair of switches SW4_1, SW4_2 can be closed when the second buck-boost voltage converter 26 provides the transfer voltage V_{TX} via the respective first middle node N_{2A}. The lightweight MCP 14 may toggle between 0×V_{BAT} and 2×V_{BAT} based on a 50% duty cycle to thereby output 1×V_{BAT} at the second voltage output 22.

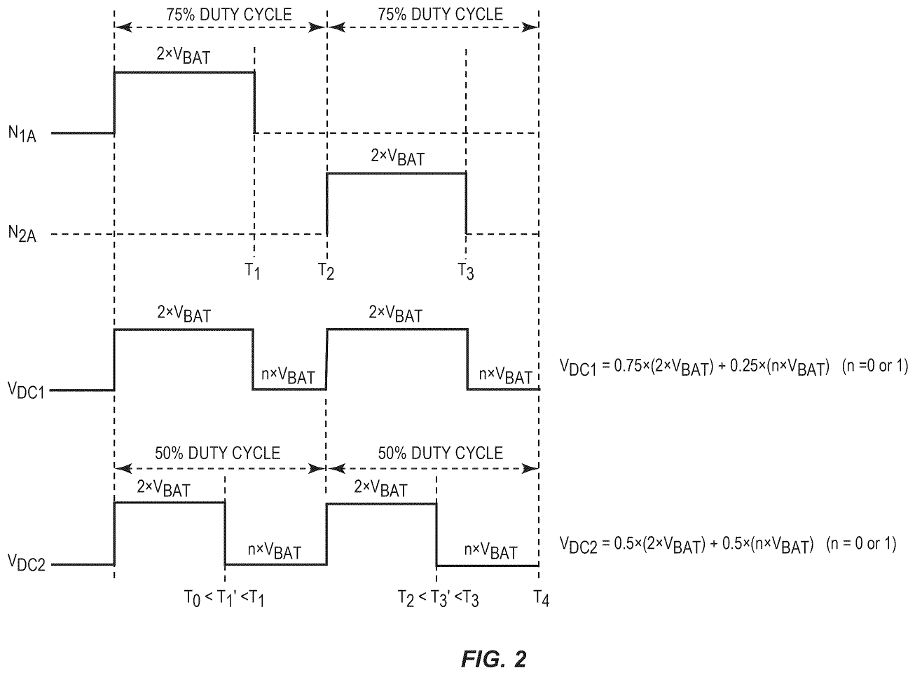

FIG. 2 is a diagram illustrating one of many operating scenarios of the dual output voltage conversion circuit 10 of FIG. 1. Common elements between FIGS. 1 and 2 are shown therein with common element numbers and will not be re-described herein.

In this specific example, the main MCP 12 is operating based on the first duty cycle 16, which corresponds to a 75%-25% duty cycle, to generate the first low-frequency voltage V_{DC1} at the first voltage output 20. In this example, the first low-frequency voltage V_{DC1} can be determined by equation (Eq. 1) below.

$${V}_{D C 1} = 0.75 \times ( 2 \times {V}_{BAT} ) + 0. 25 \times ( n \times {V}_{BAT} ) , n = 0 or 1 \qquad ( Eq . 1 )$$

According to the equation (Eq. 1), the first low-frequency voltage V_{DC1} will equal 1.5×V_{BAT} when n=0 and 1.75×V_{BAT} when n=1. The lightweight MCP 14, on the other hand, is operating based on the second duty cycle 18 that is associated with a 50%-50% duty cycle to generate the second low-frequency voltage V_{DC2} at the second voltage output 22. In this example, the second low-frequency voltage V_{DC2} can be determined by equation (Eq. 2) below.

$${V}_{D C 2} = 0.5 \times ( 2 \times {V}_{BAT} ) + 0. 5 \times ( n \times {V}_{BAT} ) , n = 0 or 1 \qquad ( Eq . 2 )$$

According to the equation (Eq. 2), the second low-frequency voltage V_{DC2} will equal 1×V_{BAT} when n=0 and 1.5×V_{BAT} when n=1. In this regard, the lightweight MCP 14 operates based on a lower duty cycle than that of the main MCP 12. In the context of the present disclosure, the second duty cycle 18 is generated independently from the first duty cycle 16 in the sense that the second duty cycle 18 may not be time aligned (a.k.a. synchronized) with the first duty cycle 16.

Between times T₀ and T₁, the respective second switch SW1_2 and the respective third switch SW1_3 in the first buck-boost voltage converter 24 are closed in order to maintain the transfer voltage V_{TX} at approximately 2×V_{BAT} at the respective first middle node N_{1A} and generate the first low-frequency voltage V_{DC1} at 2×V_{BAT} at the first voltage output 20. In the meantime, the respective first switch SW2_1 and the respective fourth switch SW2_4 in the second buck-boost voltage converter 26 are closed in order to thereby charge the respective second fly capacitor C₂ to the battery voltage V_{BAT}.

Between times T₁ and T₂, the second common switch SW_B is closed in order to generate the first low-frequency voltage V_{DC1} at n×V_{BAT} at the first voltage output 20. In the meantime, the respective second switch SW1_2 remains closed such that the 2×V_{BAT} voltage at the respective first middle node N_{1A} may not damage the respective second switch SW1_2.

Between times T₂ and T₃, the respective second switch SW2_2 and the respective third switch SW2_3 in the second buck-boost voltage converter 26 are closed in order to maintain the transfer voltage V_{TX} at approximately 2×V_{BAT} at the respective first middle node N_{2A} and generate the first low-frequency voltage V_{DC1} at 2×V_{BAT} at the first voltage output 20. In the meantime, the respective first switch SW1_1 and the respective fourth switch SW1_4 in the first buck-boost voltage converter 24 are closed in order to thereby charge the respective first fly capacitor C₁ to the battery voltage V_{BAT}.

Between times T₃ and T₄, the second common switch SW_B is closed in order to generate the first low-frequency voltage V_{DC1} at n×V_{BAT} at the first voltage output 20. In the meantime, the respective second switch SW2_2 remains closed such that the 2×V_{BAT} voltage at the respective first middle node N_{2A} may not damage the respective second switch SW2_2.

In the lightweight MCP 14, the first pair of switches SW3_1, SW3_2 are closed between times T₀ and T₁′ (T₀<T₁′<T₁) to generate the second low-frequency voltage V_{DC2} at 2×V_{BAT} at the second voltage output 22. Between times T₁′ and T₂, the third common switch SW_C is closed in order to generate the second low-frequency voltage V_{DC2} at n×V_{BAT} at the second voltage output 22. In the meantime, the first pair of switches SW3_1, SW3_2 are opened.

Between times T₂ and T₃′ (T₂<T₃′<T₃), the second pair of switches SW4_1, SW4_2 are closed in order to generate the second low-frequency voltage V_{DC2} at 2×V_{BAT} at the second voltage output 22. Between times T₃′ and T₄, the third common switch SW_C is closed in order to generate the second low-frequency voltage V_{DC2} at n×V_{BAT} at the second voltage output 22. In the meantime, the second pair of switches SW4_1, SW4_2 are opened.

Because the lightweight MCP 14 operates based on a shorter (e.g., 50%) duty cycle and the main MCP 12 operates based on a longer (e.g., 75%) duty cycle, the first pair of switches SW3_1, SW3_2 are seeing 2×V_{BAT} at the respective first middle node NIA when the third common switch SW_C is closed at time T₁′. Likewise, the second pair of switches SW4_1, SW4_2 are seeing 2×V_{BAT} at the respective first middle node N_{2A} when the third common switch SW_C is closed at time T₃′. Thus, it is important to open both the first pair of switches SW3_1, SW3_2 at time T₁′ and open both the second pair of switches SW4_1, SW4_2 at time T₃′ to prevent these switches from being damaged. These may also mean that it is undesirable to replace the first pair of switches SW3_1, SW3_2 with a single switch. By the same token, it is also undesirable to replace the second pair of switches SW4_1, SW4_2 with a single switch. Nevertheless, it is desirable to reduce a total number of the first pair of switches SW3_1, SW3_2 and the second pair of switches SW4_1, SW4_2 to help conserve space in the lightweight MCP 14.

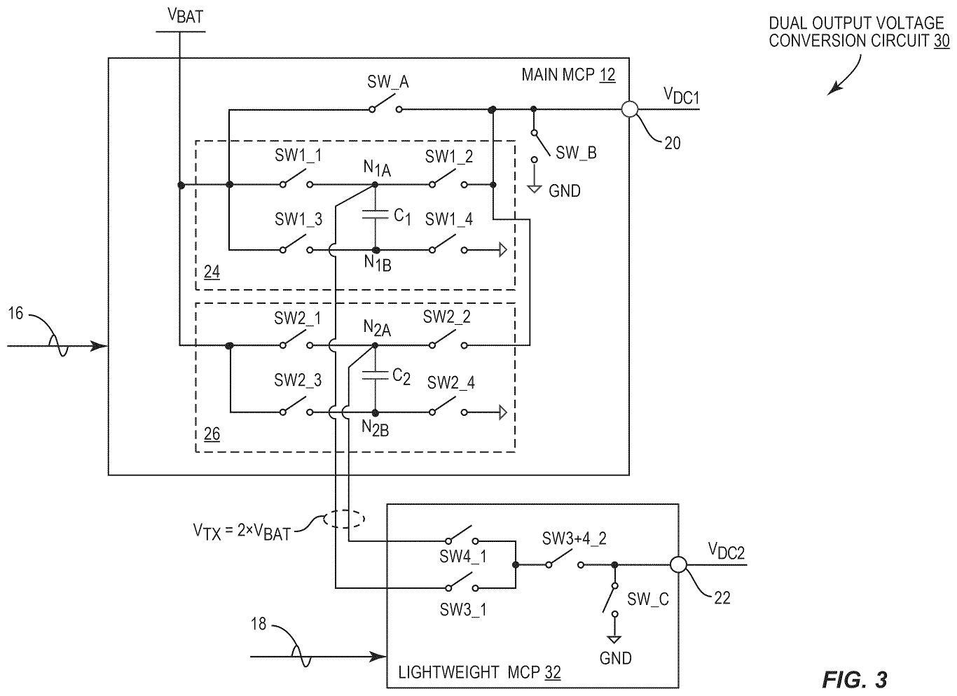

FIG. 3 is a schematic diagram of an exemplary dual output voltage conversion circuit 30 configured according to another embodiment of the present disclosure. Common elements between FIGS. 1 and 3 are shown therein with common element numbers and will not be re-described herein.

Herein, the dual output voltage conversion circuit 30 includes a lightweight MCP 32. The lightweight MCP 32 includes a first switch SW3_1, a second switch SW4_1, and a third switch SW3+4_2. Specifically, the first switch SW3_1 is coupled between the respective first middle node N_{1A} in the first buck-boost voltage converter 24 and a common node 34, the second switch SW4_1 is coupled between the respective first middle node N_{2A} in the second buck-boost voltage converter 26 and the common node 34, and the third switch SW3+4_2 is coupled between the common node 34 and the second voltage output 22. As such, the lightweight MCP 32 employs one fewer switch than the lightweight MCP 14 in FIG. 1.

In this regard, in the operating scenario illustrated in FIG. 2, the first switch SW3_1 and the third switch SW3+4_2 are both closed between times T₀ and T₁′ and are both opened between times T₁′ and T₂. Similarly, the second switch SW4_1 and the third switch SW3+4_2 are both closed between times T₂ and T₃′ and are both opened between times T₃′ and T₄.

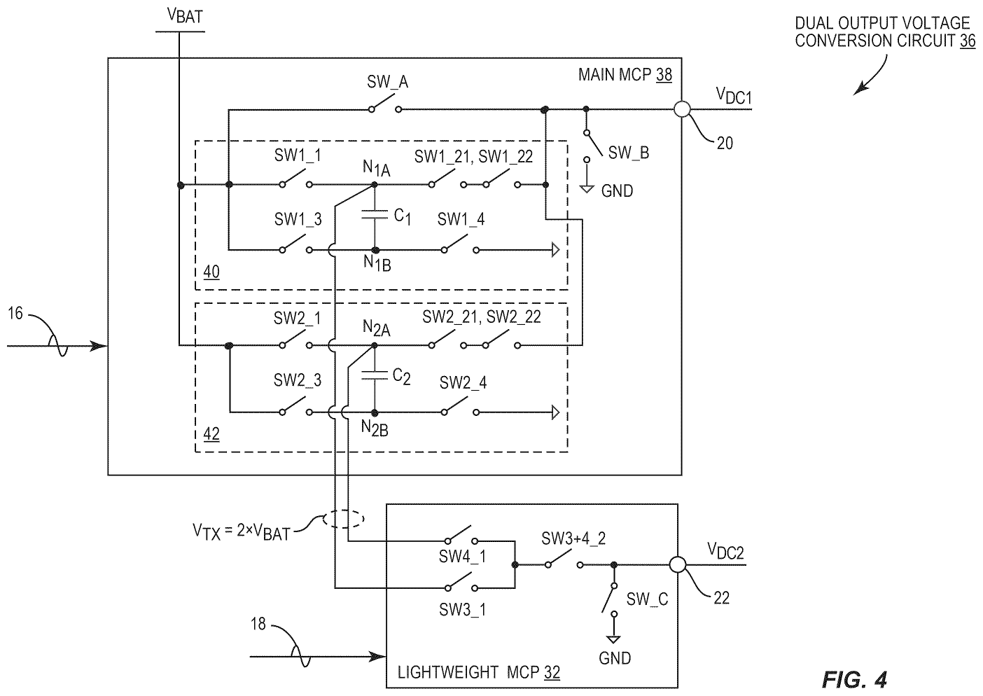

FIG. 4 is a schematic diagram of an exemplary dual output voltage conversion circuit 36 configured according to another embodiment of the present disclosure. Common elements between FIGS. 3 and 4 are shown therein with common element numbers and will not be re-described herein.

In this embodiment, the dual output voltage conversion circuit 36 includes a main MCP 38, which includes a first buck-boost voltage converter 40 and a second buck-boost voltage converter 42. In the first buck-boost voltage converter 40, the respective second switch SW1_2 (as shown in FIGS. 1 and 3) is replaced by a respective pair of second switches SW1_21, SW1_22. In the second buck-boost voltage converter 42, the respective second switch SW2_2 (as shown in FIGS. 1 and 3) is replaced by a respective pair of second switches SW2_21, SW2_22. In this regard, the respective pair of second switches SW1_21, SW1_22 will be opened when the respective second switch SW1_2 is opened and closed when the respective second switch SW1_2 is closed. Likewise, the respective pair of second switches SW2_21, SW2_22 will be opened when the respective second switch SW2_2 is opened and closed when the respective second switch SW2_2 is closed.

One particular benefit of such an arrangement is that the respective pair of second switches SW1_21, SW1_22 in the first buck-boost voltage converter 40 can be protected from being damaged by the 2×V_{BAT} presenting at the respective first middle node NIA when the second common switch SW_B is closed. Likewise, the respective pair of second switches SW2_21, SW2_22 in the second buck-boost voltage converter 42 can be protected from being damaged by the 2×V_{BAT} presenting at the respective first middle node N_{2A} when the second common switch SW_B is closed. As a result, it is possible to operate the main MCP 12 based on a shorter duty cycle than that of the lightweight MCP 14.

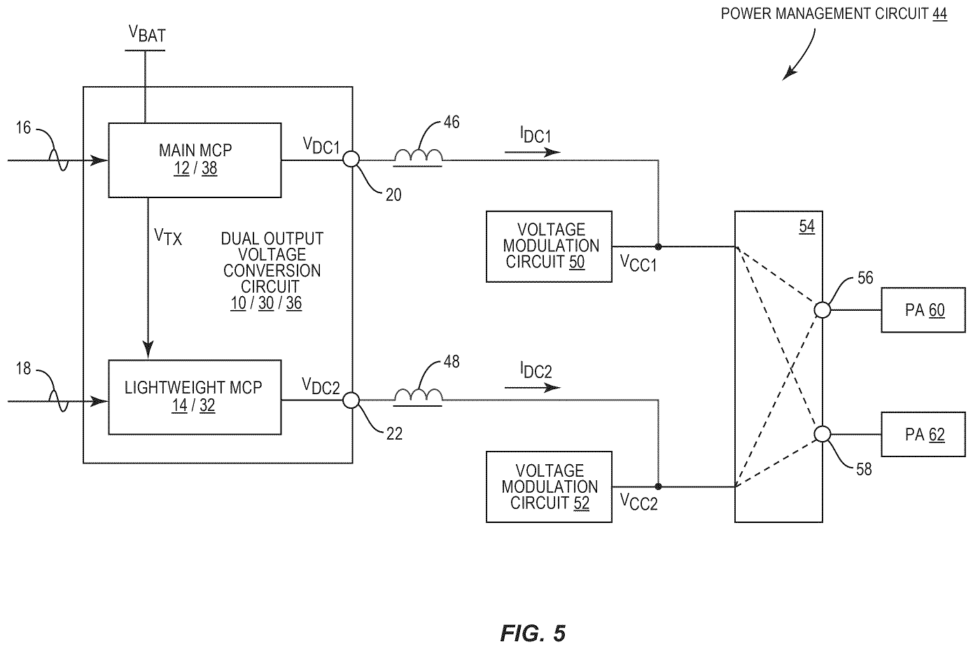

FIG. 5 is a schematic diagram of an exemplary power management circuit 44 wherein the dual output voltage conversion circuit 10 of FIG. 1, the dual output voltage conversion circuit 30 of FIG. 3, and the dual output voltage conversion circuit 36 of FIG. 4 can be provided. Common elements between FIGS. 1, 3, 4, and 5 are shown therein with common element numbers and will not be re-described herein.

Herein, the power management circuit 44 includes a first power inductor 46 and a second power inductor 48. The first power inductor 46 is coupled to the first voltage output 20 and configured to generate a first low-frequency current I_{DC1} based on the first low-frequency voltage V_{DC1}. The second power inductor 48 is coupled to the second voltage output 22 and configured to generate a second low-frequency current I_{DC2} based on the second low-frequency voltage V_{DC2}.

The power management circuit 44 also includes a first voltage modulation circuit 50 and a second voltage modulation circuit 52. The first voltage modulation circuit 50 is configured to generate a first modulated voltage V_{CC1} and the second voltage modulation circuit 52 is configured to generate a second modulated voltage V_{CC2}. In context of the present disclosure, the first modulated voltage V_{CC1} and the second modulated voltage V_{CC2} can either be envelope tracking (ET) voltages or average power tracking (APT) voltages.

The power management circuit 44 can further include a switching circuit 54. The switching circuit 54 is coupled to the first voltage modulation circuit 50, the first power inductor 46, the second voltage modulation circuit 52, and the second power inductor 48. The switching circuit 54 is further coupled to a first output node 56 and a second output node 58, which are coupled respectively to a first power amplifier 60 and a second power amplifier 62. Herein, the switching circuit 54 is configured to provide the first modulated voltage V_{CC1} and the first low-frequency current I_{DC1} to any one of the first output node 56 and the second output node 58. The switching circuit 54 is also configured to provide the second modulated voltage V_{CC2} and the second low-frequency current I_{DC2} to another one of the first output node 56 and the second output node 58. As an example, the switching circuit 54 may provide the first modulated voltage V_{CC1} and the first low-frequency current I_{DC1} to the first output node 56 and provide the second modulated voltage V_{CC2} and the second low-frequency current I_{DC2} to the second output node 58, or vice versa.

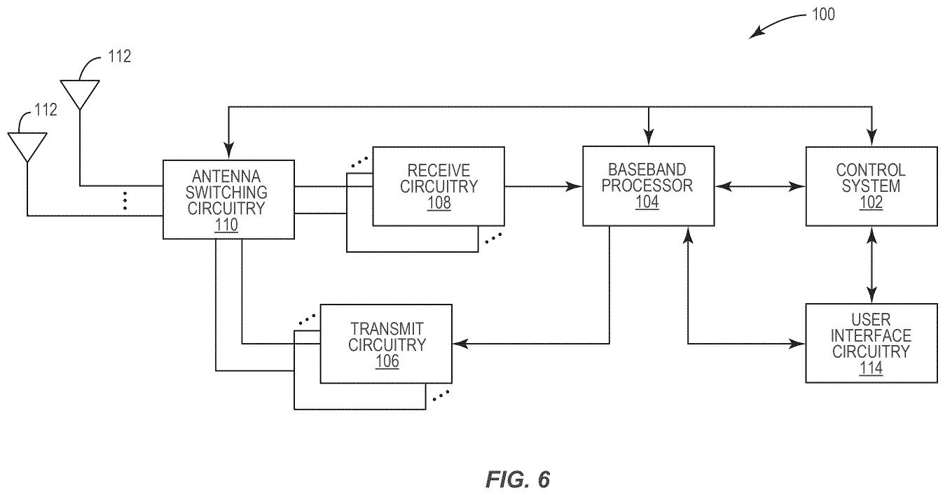

The power management circuit 44 of FIG. 5 can be provided in a communication device (e.g., a wireless device) to support the embodiments described above. In this regard, FIG. 6 is a schematic diagram of an exemplary communication device 100 wherein the power management circuit 44 of FIG. 5 can be provided.

Herein, the communication device 100 can be any type of communication devices, such as mobile terminals, smart watches, tablets, computers, navigation devices, access points, base stations (e.g., eNB, gNB, etc.), and any other type of wireless communication devices that support wireless communications, such as cellular, wireless local area network (WLAN), Bluetooth, Ultra-wideband (UWB), and near field communications. The communication device 100 will generally include a control system 102, a baseband processor 104, transmit circuitry 106, receive circuitry 108, antenna switching circuitry 110, multiple antennas 112, and user interface circuitry 114. In a non-limiting example, the control system 102 can be a field-programmable gate array (FPGA), as an example. In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using an analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission, and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art.

In an exemplary embodiment, the power management circuit 44 may be provided between the transmit circuitry 106 and the antenna switching circuitry 110. In another exemplary embodiment, the power management circuit 44 may be provided in the antenna switching circuitry 110.

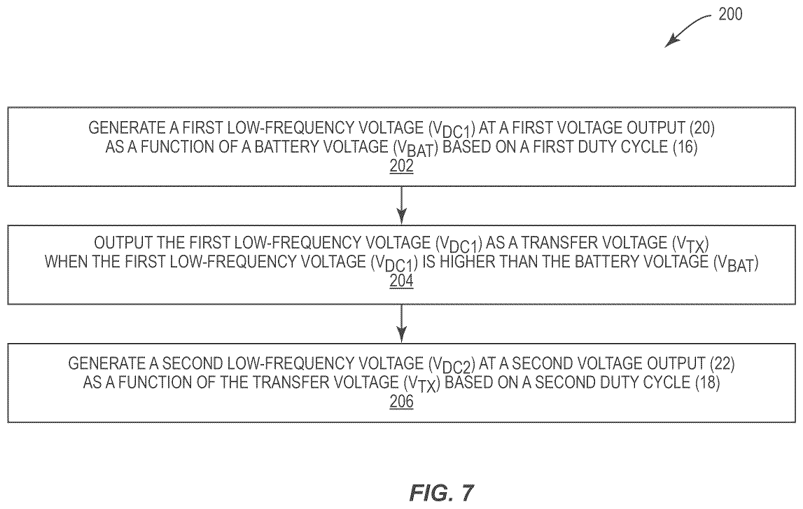

In an embodiment, the dual output voltage conversion circuit 10 of FIG. 1, the dual output voltage conversion circuit 30 of FIG. 3, and the dual output voltage conversion circuit 36 of FIG. 4 can all be operated based on a process. In this regard, FIG. 7 is a flowchart of an exemplary process 200 for operating the dual output voltage conversion circuit 10 of FIG. 1, the dual output voltage conversion circuit 30 of FIG. 3, and the dual output voltage conversion circuit 36 of FIG. 4.

Herein, the process 200 includes generating the first low-frequency voltage V_{DC1} at the first voltage output 20 as a function of the battery voltage V_{BAT} and based on the first duty cycle 16 (step 202). The process 200 also includes outputting the first low-frequency voltage V_{DC1} as the transfer voltage V_{TX} when the first low-frequency voltage V_{DC1} is higher than the battery voltage V_{BAT} (step 204). The process 200 also includes generating the second low-frequency voltage V_{DC2} at the second voltage output 22 as a function of the transfer voltage V_{TX} and based on the second duty cycle 18 (step 206).

Those skilled in the art will recognize improvements and modifications to the preferred embodiments of the present disclosure. All such improvements and modifications are considered within the scope of the concepts disclosed herein and the claims that follow.

What is claimed is:

1. A dual output voltage conversion circuit comprising:
a main multi-level charge pump (MCP) configured to:
generate a first low-frequency voltage at a first voltage output as a function of a battery voltage based on a first duty cycle; and
output the first low-frequency voltage as a transfer voltage when the first low-frequency voltage is higher than the battery voltage; and
a lightweight MCP configured to:
receive the transfer voltage from the main MCP; and
generate a second low-frequency voltage at a second voltage output as a function of the transfer voltage based on a second duty cycle.

2. The dual output voltage conversion circuit of claim 1, wherein the main MCP is further configured to output the first low-frequency voltage as the transfer voltage when the first low-frequency voltage is substantially equal to twice the battery voltage.

3. The dual output voltage conversion circuit of claim 1, wherein the second duty cycle is generated independently from the first duty cycle to thereby cause the lightweight MCP to operate independently from the main MCP.

4. The dual output voltage conversion circuit of claim 1, wherein:
the main MCP is further configured to toggle between a zero-times multiple (0×), a one-times multiple (1×), and/or a two-times multiple (2×) of the battery voltage based on the first duty cycle; and
the lightweight MCP is further configured to toggle between a zero-times multiple (0×), a one-half-times multiple (0.5×), and/or a one-times multiple (1×) of the transfer voltage based on the second duty cycle.

5. The dual output voltage conversion circuit of claim 1, wherein the main MCP comprises a first buck-boost voltage converter and a second buck-boost voltage converter coupled in parallel between the battery voltage and the first voltage output and configured to alternately provide the transfer voltage to the lightweight MCP.

6. The dual output voltage conversion circuit of claim 5, wherein the second duty cycle is lower than or equal to the first duty cycle.

7. The dual output voltage conversion circuit of claim 5, wherein:
the main MCP further comprises:
a first common switch coupled between the battery voltage and the first voltage output; and
a second common switch coupled between the first voltage output and a ground; and
each of the first buck-boost voltage converter and the second buck-boost voltage converter comprises:
a respective first switch coupled between the battery voltage and a respective first middle node;
a respective second switch coupled between the respective first middle node and the first voltage output;
a respective third switch coupled between the battery voltage and a respective second middle node;
a respective fourth switch coupled between the respective second middle node and the ground; and
a respective fly capacitor coupled between the respective first middle node and the respective second middle node.

8. The dual output voltage conversion circuit of claim 7, wherein the lightweight MCP comprises:
a third common switch coupled between the second voltage output and the ground;
a first pair of switches coupled in series between the respective first middle node in the first buck-boost voltage converter and the second voltage output; and
a second pair of switches coupled in series between the respective first middle node in the second buck-boost voltage converter and the second voltage output;
wherein one of the first pair of switches and the second pair of switches is opened when the third common switch is closed.

9. The dual output voltage conversion circuit of claim 8, wherein:
the first pair of switches are both closed, and the second pair of switches are both opened when the transfer voltage is received via the respective first middle node in the first buck-boost voltage converter; and
the second pair of switches are both closed, and the first pair of switches are both opened when the transfer voltage is received via the respective first middle node in the second buck-boost voltage converter.

10. The dual output voltage conversion circuit of claim 7, wherein the lightweight MCP comprises:
a third common switch coupled between the second voltage output and the ground;
a first switch coupled between the respective first middle node in the first buck-boost voltage converter and a common node;
a second switch coupled between the respective first middle node in the second buck-boost voltage converter and the common node; and
a third switch coupled between the common node and the second voltage output;
wherein one of the first switch, the second switch, and the third switch are opened when the third common switch is closed.

11. The dual output voltage conversion circuit of claim 10, wherein:
the first switch and the third switch are both closed, and the second switch is opened when the transfer voltage is received via the respective first middle node in the first buck-boost voltage converter; and
the second switch and the third switch are both closed, and the first switch is opened when the transfer voltage is received via the respective first middle node in the second buck-boost voltage converter.

12. The dual output voltage conversion circuit of claim 5, wherein:
the main MCP further comprises:
a first common switch coupled between the battery voltage and the first voltage output; and
a second common switch coupled between the first voltage output and a ground; and
each of the first buck-boost voltage converter and the second buck-boost voltage converter comprises:
a respective first switch coupled between the battery voltage and a respective first middle node;
a respective pair of second switches coupled in series between the respective first middle node and the first voltage output;
a respective third switch coupled between the battery voltage and a respective second middle node;
a respective fourth switch coupled between the respective second middle node and the ground; and
a respective fly capacitor coupled between the respective first middle node and the respective second middle node.

13. A wireless device comprising a power management circuit comprising:
a dual output voltage conversion circuit comprising:
a main multi-level charge pump (MCP) configured to:
generate a first low-frequency voltage at a first voltage output as a function of a battery voltage based on a first duty cycle; and
output the first low-frequency voltage as a transfer voltage when the first low-frequency voltage is higher than the battery voltage; and
a lightweight MCP configured to:
receive the transfer voltage from the main MCP; and
generate a second low-frequency voltage at a second voltage output as a function of the transfer voltage based on a second duty cycle.

14. The wireless device of claim 13, wherein the power management circuit further comprises:
a first power inductor coupled to the first voltage output and configured to generate a first low-frequency current based on the first low-frequency voltage; and
a second power inductor coupled to the second voltage output and configured to generate a second low-frequency current based on the second low-frequency voltage.

15. The wireless device of claim 14, wherein the power management circuit further comprises:
a first voltage modulation circuit configured to generate a first modulated voltage;
a second voltage modulation circuit configured to generate a second modulated voltage;
a switching circuit coupled to the first voltage modulation circuit, the first power inductor, the second voltage modulation circuit, and the second power inductor, the switching circuit is configured to:
provide the first modulated voltage and the first low-frequency current to any one of a first output node and a second output node; and
provide the second modulated voltage and the second low-frequency current to another one of the first output node and the second output node; and
a first power amplifier coupled to the first output node; and
a second power amplifier coupled to the second output node.

16. The wireless device of claim 13, wherein the main MCP is further configured to output the first low-frequency voltage as the transfer voltage when the first low-frequency voltage is substantially equal to twice the battery voltage.

17. The wireless device of claim 13, wherein the second duty cycle is generated independently from the first duty cycle to thereby cause the lightweight MCP to operate independently from the main MCP.

18. The wireless device of claim 13, wherein the main MCP comprises a first buck-boost voltage converter and a second buck-boost voltage converter coupled in parallel between the battery voltage and the first voltage output and configured to alternately provide the transfer voltage to the lightweight MCP.

19. A method for operating a dual output voltage conversion circuit comprising:
generating a first low-frequency voltage at a first voltage output as a function of a battery voltage based on a first duty cycle;
outputting the first low-frequency voltage as a transfer voltage when the first low-frequency voltage is higher than the battery voltage; and
generating a second low-frequency voltage at a second voltage output as a function of the transfer voltage based on a second duty cycle.

20. The method of claim 19, further comprising outputting the first low-frequency voltage as the transfer voltage when the first low-frequency voltage is substantially equal to twice the battery voltage.
